(19) United States
(12) Patent Application Publication
(10) Pub. No.: US 2024/0175146 A1
(43) Pub. Date: May 30, 2024

(54) ELECTROLYSIS SYSTEM

(71) Applicants: National Taiwan University of Science and Technology, TAIPEI CITY (TW); BenQ Materials Corporation, Taoyuan City (TW)

(72) Inventors: Bing-Joe HWANG, TAIPEI CITY (TW); Di-Yan WANG, Taichung City (TW); Wei-Nien SU, Taipei City (TW); Meng-Che TSAI, TAIPEI CITY (TW); Shih-Mao PENG, Taichung City (TW); Sheng-Chiang YANG, TAIPEI CITY (TW)

(21) Appl. No.: 18/518,593

(22) Filed: Nov. 23, 2023

(30) Foreign Application Priority Data
Nov. 30, 2022 (TW) 111145856

(51) Int. Cl. C25B 9/19; C25B 1/02; C25B 1/24; C25B 11/043; C25B 11/065; C25B 11/075; C25B 13/07; C25B 13/08

(52) U.S. Cl. CPC C25B 9/19; C25B 1/02; C25B 1/24; C25B 11/043; C25B 11/065; C25B 11/075; C25B 13/07; C25B 13/08

(57) ABSTRACT

An electrolysis system is provided in some embodiments of the present disclosure, including an anode reaction chamber, a cathode reaction chamber and a spacer. The anode reaction chamber includes an anode reaction solution and an anode immersed in the anode reaction solution, in which the anode reaction solution includes an iodide ion, and a material of the anode includes a carbon material. The cathode reaction chamber includes a cathode reaction solution and a cathode immersed in the cathode reaction solution, in which the cathode reaction solution includes a hydrogen ion. The spacer separates the anode reaction chamber and the cathode reaction chamber, in which the spacer allows a cation or an anion to pass through, so that the anode reaction chamber and the cathode reaction chamber are electrically connected to each other.

### CROSS-REFERENCE TO RELATED APPLICATION

This application claims priority to Taiwan Application Serial Number TW 111145856, filed Nov. 30, 2022, which is herein incorporated by reference.

### BACKGROUND

### Field of Invention

The present disclosure relates to an electrolysis system, and more particularly, to an electrolysis system that can generate hydrogen gas and iodine.

### Description of Related Art

In a known reaction system for producing hydrogen gas through water electrolysis, there is a problem of high energy consumption (theoretical potential of 1.23 volts) caused by a too slow rate of oxygen evolution reaction at an anode, and oxygen gas will pass through a spacer between the anode and a cathode, causing purity of the hydrogen gas to decrease.

Therefore, how to provide an electrolysis system that can improve reaction efficiency of the anode and improve the purity of the hydrogen gas is an issue to be solved.

### SUMMARY

An electrolysis system is provided in some embodiments of the present disclosure, including an anode reaction chamber, a cathode reaction chamber and a spacer. The anode reaction chamber includes an anode reaction solution and an anode immersed in the anode reaction solution, in which the anode reaction solution includes an iodide ion, and a material of the anode includes a carbon material, and the anode reaction chamber performs an iodide oxidation reaction. The cathode reaction chamber includes a cathode reaction solution and a cathode immersed in the cathode reaction solution, in which the cathode reaction solution includes a hydrogen ion. The spacer separates the anode reaction chamber and the cathode reaction chamber, in which the spacer allows a cation or an anion to pass through; the anode reaction chamber and the cathode reaction chamber are electrically connected to each other.

In some embodiments, the material of the anode is made of the carbon material.

In some embodiments, the anode includes an anode body and an anode catalyst layer disposed on the anode body, in which a material of the anode body or the anode catalyst layer includes the carbon material.

In some embodiments, the carbon material includes a carbon fiber paper, a conductive carbon, a carbon cloth, a graphite, a carbon sphere or a combination thereof.

In some embodiments, the carbon material is not subjected to surface modification treatment or is subjected to surface modification treatment.

In some embodiments, the anode reaction solution includes a first solute and a second solute.

In some embodiments, the first solute includes metal iodide, and the second solute includes perchloric acid, perchlorate, metal hydroxide, or a combination thereof.

In some embodiments, a concentration of the first solute in the anode reaction solution is in a range of from 5×10⁻⁴ M to 2 M, and a concentration of the second solute in the anode reaction solution is in a range of from 0.05 M to 2 M.

In some embodiments, comparing with oxygen, the iodide ion, an iodine molecule, a triiodide ion or a combination thereof is less available to pass through the spacer.

In some embodiments, the spacer includes a perfluorosulfonic acid membrane, a sulfonated chitosan membrane, a cross-linked graphene oxide membrane, or a combination thereof.

An electrolysis system is provided in some embodiments of the present disclosure, including an anode reaction chamber, a cathode reaction chamber and a spacer. The anode reaction chamber includes an anode reaction solution and an anode immersed in the anode reaction solution, in which the anode reaction solution includes an iodide ion, and a material of the anode is made of a carbon material, and the anode reaction chamber performs an iodide oxidation reaction. The cathode reaction chamber includes a cathode reaction solution and a cathode immersed in the cathode reaction solution, in which the cathode reaction solution includes a hydrogen ion to produce hydrogen gas.

In some embodiments, the electrolysis system further comprises a spacer, in which the spacer separates the anode reaction chamber and the cathode reaction chamber, wherein the spacer allows a cation or an anion to pass through, so that the anode reaction chamber and the cathode reaction chamber are electrically connected to each other.

In some embodiments, the carbon material includes a carbon fiber paper, a conductive carbon, a carbon cloth, a graphite, a carbon sphere or a combination thereof.

In some embodiments, a material of the cathode includes platinum.

In some embodiments, the anode reaction chamber further includes a reference electrode immersed in the anode reaction solution.

### BRIEF DESCRIPTION OF THE DRAWINGS

Read the following implementation methods with accompanying drawings to clearly understand the viewpoint of the application. It should be noted that, in accordance with the standard practice in the industry, various features are not drawn to scale. In fact, the dimensions of the various features may be arbitrarily increased or reduced for clarity of discussion. Furthermore, the same reference numerals denote the same elements.

FIG. 1A is a schematic diagram of an electrolysis system according to some embodiments of the present application.

FIG. 1B is a schematic diagram of an electrolysis system according to other embodiments of the present application.

FIG. 2 is a relationship diagram of current density and voltage obtained according to tests of various conditions in Example 1.

FIG. 3 is a relationship diagram of current density and voltage obtained according to tests of various conditions in Example 2.

FIG. 4A, FIG. 4B and FIG. 4C are relationship diagrams of current density and voltage obtained according to tests of various conditions in Example 3-1, Example 3-2 and Example 3-3, respectively.

FIG. 5 is a relationship diagram of current density and voltage obtained according to tests of various conditions in Example 4.

### DETAILED DESCRIPTION

When an element such as a layer, film, region, or substrate is referred to as being “on” or “connected to” another element, it can be directly on or connected to the other element, or an intermediate element may also be present. In contrast, when an element is referred to as being “directly on” or “directly connected to” another element, there is no intermediate element. As used herein, “connected” may refer to physical and/or electrical connection. Furthermore, “electrically connected” or “coupled” may refer to the presence of another element between two elements.

Furthermore, relative terms such as “lower” or “bottom” and “upper” or “top” may be used herein to describe one element's relationship to another element as shown in the figures. It will be understood that the relative terms are intended to encompass different orientations of the device in addition to the orientation depicted in the figures. For example, if the device in one of the figures is turned over, one element described as being on a “lower” side of another element would then be oriented on an “upper” side of the other element. Thus, the exemplary term “lower” can encompass both an orientation of “lower” and “upper,” depending on the particular orientation of the figures. Similarly, if the device in one of the figures is turned over, one element described as “below” or “beneath” another element would then be oriented “over” the other element. Thus, the exemplary terms “below” or “beneath” can encompass both the orientations of over and below.

As used herein, the term “about”, “approximately”, or “substantially” includes a stated value and an average value within an acceptable deviation range of a specific value determined by those of ordinary skill in the art, taking into account the discussed measurement and the specific number of errors associated with the measurement (i.e., the limitation of the measurement system). For example, “about” can mean within one or more standard deviations of the stated values.

Unless otherwise defined, all terms (including technical and scientific terms) used herein have the same meaning as commonly understood by those of ordinary skill in the art of the present invention. It will be further understood that terms such as those defined in commonly used dictionaries should be interpreted as having meanings consistent with their meanings in the related technologies and the context of the present invention, and will not be interpreted as idealized meaning or an overly formal meaning, unless explicitly defined as such in this article.

It should be noted that, unless otherwise specified, when the following embodiments are shown or described as a series of operations or events, the description order of these operations or events should not be limited. For example, some operations or events may be performed in a different order than in the present application, some operations or events may occur at the same time, some operations or events may not be used, and/or some operations or events may be repeated. Also, the actual process may require additional operations before, during, or after each step to completely form the circuit board. Therefore, this application will probably briefly describe some of the additional operations.

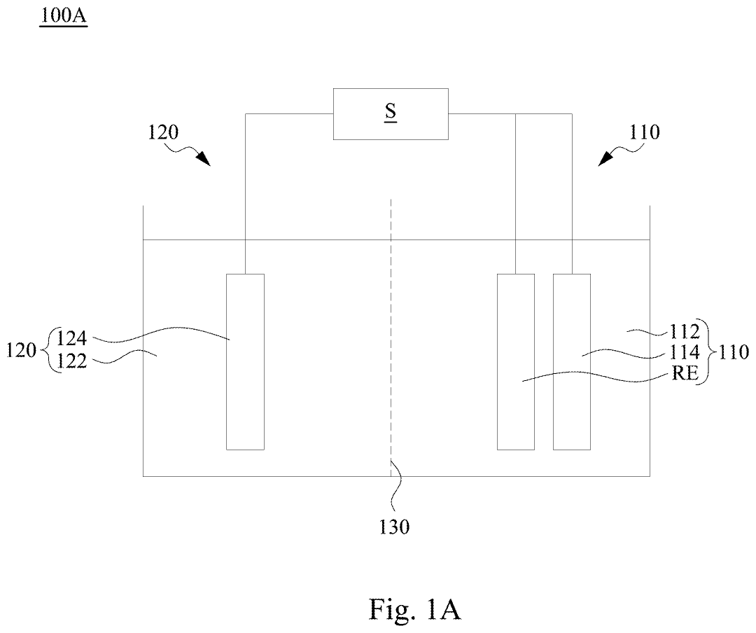

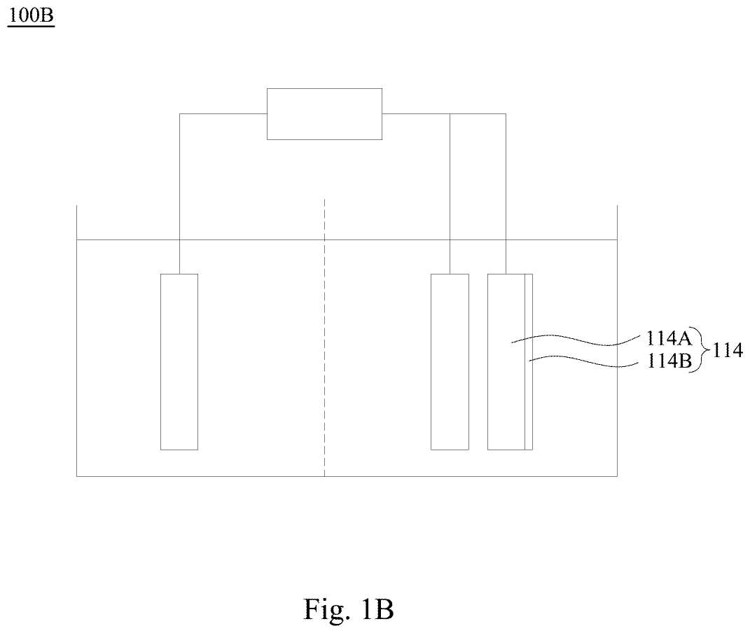

Please refer to FIG. 1A. An electrolysis system 100A includes a power source S, an anode reaction chamber 110, a cathode reaction chamber 120 and a spacer 130. The anode reaction chamber 110 includes an anode reaction solution 112, an anode 114 immersed in the anode reaction solution 112, and a reference electrode RE immersed in the anode reaction solution 112, in which the anode reaction solution 112 includes an iodide ion (I⁻), and the anode 114 includes a carbon material. The cathode reaction chamber 120 includes a cathode reaction solution 122 and a cathode 124 immersed in the cathode reaction solution 122, in which the cathode reaction solution 122 includes a hydrogen ion. The anode 114, the reference electrode RE and the cathode 124 are electrically connected to the power source S. The spacer 130 separates the anode reaction chamber 110 and the cathode reaction chamber 120, in which the spacer 130 allows a cation or an anion to pass through, so that the anode reaction chamber 110 and the cathode reaction chamber 120 are electrically connected to each other.

The electrolysis system 100A can make the anode reaction chamber 110 and the cathode reaction chamber 120 respectively perform following reactions by regulating the anode reaction solution 112 and the cathode reaction solution 122.

The anode reaction chamber 110 performs iodide oxidation reaction (IOR):

3I⁻(aq)→-I₃⁻(aq)+2e⁻ and 2I⁻(aq)→I₂(s)+2e⁻

The cathode reaction chamber 120 performs hydrogen evolution reaction (HER):

2H⁺(aq)+2e⁻→H₂(g)

In known water electrolysis reaction for producing hydrogen gas, oxygen evolution reaction of the anode has an issue of a slow reaction rate. Because of high energy consumption, a required voltage is higher (theoretical potential of 1.23 volts), and it is often necessary to additionally use a catalyst to reduce the energy required for the reaction. Relatively speaking, the electrolysis system 100A of the present application adjusts a composition of the anode reaction solution 112 to include the iodide ion, so that the anode reaction chamber 110 performs iodide oxidation reaction with a lower voltage (theoretical potential of 0.54 volts), thereby reducing the energy required for the reaction, improving convenience of reaction execution, and obtaining solid iodine molecules with high commercial value at the same time.

In some embodiments, the electrolysis system 100A is a three-electrode system. In some other embodiments, the electrolysis system 100A is a two-electrode system (excluding the reference electrode RE). In some other embodiments, compared to a two-chamber structure of the electrolysis system 100A, the shape of each element, the stacking or assembly relationship and an opening position in the electrolysis system 100A may be adjusted. For example, the anode reaction chamber 110, the cathode reaction chamber 120, and the spacer 130 are provided in a sandwich structure like the membrane electrode assembly (MEA) in a fuel cell.

In some embodiments, as shown in FIG. 1A, the anode 114 is made of the carbon material, that is, the entire material of the anode 114 is the carbon material. Compared with other materials (e.g., titanium material) used for the anode 114, the voltage required by the electrolysis system 100A is lower when the anode 114 is made of the carbon material. In some embodiments, the carbon material includes carbon fiber paper, conductive carbon (e.g., Super P series products), carbon cloth, carbon nanotubes, graphite, carbon sphere or a combination thereof. Compared with the conductive carbon, carbon cloth, or graphite, when the anode 114 is made of the carbon fiber paper, the voltage required by the electrolysis system 100A is lower. In some other embodiments, the anode 114 may include a catalyst. For example, please refer to FIG. 1B, the electrolysis system 1001B is basically similar to the electrolysis system 100A, and the difference is that the anode 114 in the electrolysis system 1001B includes an anode body 114A and an anode catalyst layer 114B disposed on the anode body 114A, in which a material of the anode body 114A or the anode catalyst layer 114B includes the carbon material. For example, the anode catalyst layer 114B completely or partially covers a surface of the anode body 114A.

In some embodiments, the carbon material is not subjected to surface modification treatment or is subjected to surface modification treatment. In some embodiments, the surface modification treatment of the carbon material includes ultraviolet light and ozone treatment, or surface doping treatment (e.g., the carbon material is nitrogen-doped carbon spheres). In one embodiment, when the carbon material is the carbon fiber paper, no matter whether the carbon fiber paper is treated with ultraviolet light or ozone, the voltage required by the electrolysis system 100A is the same.

In some embodiments, the anode reaction solution 112 includes a first solute and a second solute. In some embodiments, the first solute includes metal iodide (e.g., sodium iodide or potassium iodide), and the second solute includes perchloric acid, perchlorate salt (e.g., lithium perchlorate), metal hydroxide (e.g., potassium hydroxide) or a combination thereof, in which compared with when the second solute is perchlorate salt or metal hydroxide, when the second solute is perchloric acid, the voltage required by the electrolysis system 100A is lower. In some embodiments, a concentration of the first solute in the anode reaction solution 112 is in a range of from 5×10⁻⁴ M to 2 M (e.g., 5×10⁻⁴ M, 1×10⁻³ M, 5×10⁻³ M, 0.01 M, 0.05 M, 0.1 M, 0.2 M, 0.3 M, 0.4 M, 0.5 M, 0.6 M, 0.7 M, 0.8 M, 0.9 M, 1.0 M, 1.1 M, 1.2 M, 1.3 M, 1.4 M, 1.5 M, 1.6 M, 1.7 M, 1.8 M, 1.9 M, 2 M or a value in any interval above), and a concentration of the second solute in the anode reaction solution 112 is in a range of from 0.05 M to 2 M (e.g., 0.05 M, 0.1 M, 0.2 M, 0.3 M, 0.4 M, 0.5 M, 0.6 M, 0.7 M, 0.8 M, 0.9 M, 1.0 M, 1.1 M, 1.2 M, 1.3 M, 1.4 M, 1.5 M, 1.6 M, 1.7 M, 1.8 M, 1.9 M, 2 M or a value in any interval above), in which when the concentration increases, the voltage required by the electrolysis system 100A decreases.

In some embodiments, the cathode 124 includes platinum. In some embodiments, the cathode reaction solution 122 includes sulfuric acid or perchloric acid. In some embodiments, a solute concentration in the cathode reaction solution 122 is in a range of from 0.05 M to 2 M (e.g., 0.05 M, 0.1 M, 0.2 M, 0.3 M, 0.4 M, 0.5 M, 0.6 M, 0.7 M, 0.8 M, 0.9 M, 1.0 M, 1.1 M, 1.2 M, 1.3 M, 1.4 M, 1.5 M, 1.6 M, 1.7 M, 1.8 M, 1.9 M, 2 M or a value in any interval above).

In some embodiments, the reference electrode RE is a saturated calomel electrode (SCE) or a reversible hydrogen electrode (RHE).

In some embodiments, the spacer 130 is a proton (or cation) exchange membrane (allowing cations to pass through, such as a chitosan-based exchange membrane) or an anion exchange membrane (allowing anions to pass through), in which the proton (or cation) exchange membrane is generally applicable when the anode reaction solution 112 and the cathode reaction solution 122 are acidic solutions, and the pH condition of the anode reaction solution 112 and the cathode reaction solution 122 applied for the anion exchange membrane is vice versa. In some embodiments, the proton exchange membrane may be a perfluorosulfonic acid membrane (e.g., Nafion®), a sulfonated chitosan membrane, a cross-linked graphene oxide membrane or a combination thereof.

In some embodiments, comparing with oxygen, iodide ions (I⁻), iodine molecules (I₂) and triiodide ions (I₃⁻) are less available to pass through the spacer 130. In some embodiments, iodide ions (I⁻), iodine molecules (I₂) and triiodide ions (I₃⁻) are unable to pass through the spacer 130. For example, when the spacer 130 adopts the proton exchange membrane or the spacer 130 adopts the anion exchange membrane with a pore size smaller than the iodide ion, it can make the iodide ions (I⁻), iodine molecules (I₂) and triiodide ions (I₃⁻) unable to pass through the spacer 130. It should be noted that in known oxygen evolution reaction, oxygen gas in the anode reaction chamber can pass through the spacer to the cathode reaction chamber, reducing the purity of the hydrogen gas in the cathode reaction chamber. Relatively speaking, the products 13 and 12 generated by iodide oxidation reaction in the anode reaction chamber 110 of the electrolysis system 100A cannot pass through the spacer 130. When the applied potential is low enough, it is possible to have the products 13 and 12 generated by iodide oxidation reaction in the anode reaction chamber 110 without having the oxygen evolution reaction, so there is no aforementioned issue of impurity in hydrogen gas, and thus the cathode reaction chamber 120 can generate hydrogen gas with higher purity. In other words, the applied potential for electrolysis across the anode reaction chamber 110 and the cathode reaction chamber 120 is low enough to avoid O₂ evolution, but high enough to have I⁻ oxidation (I₂ generation), while H₂ gas is still produced in the anode reaction chamber 110.

The following provides a series of examples of conditional testing of the electrolysis system to specifically illustrate some implementations of the present disclosure. The following examples used the three-electrolysis system as shown in FIG. 1A.

Example 1, Comparison of Anodic Iodide Oxidation Reaction (IOR) and Oxygen Evolution Reaction (OER)

First, according to the electrolysis system 100A shown in FIG. 1A, three different sets of electrolysis systems were set respectively to compare the difference in applied potentials required for the reactions when the electrolysis systems performed different anode half-reactions or when different anodes were used. Specifically, the anode of one set performed iodide oxidation reaction (the anode reaction solution was 0.1 M sodium iodide and 0.1 M perchloric acid, and the anode was carbon fiber paper), and the anodes of the other two sets performed oxygen evolution reaction (the anode reaction solutions were 0.5 M sulfuric acid, and the anode of one set was carbon fiber paper, and the anode of the other set was iridium dioxide) as control groups. In addition, the cathode, cathode reaction solution, reference electrode, and spacer of the three groups were all the same. The cathode was made of platinum, and the cathode reaction solution was 0.5 M sulfuric acid, and the reference electrode was a saturated calomel electrode, and the spacer was a perfluorosulfonic acid membrane.

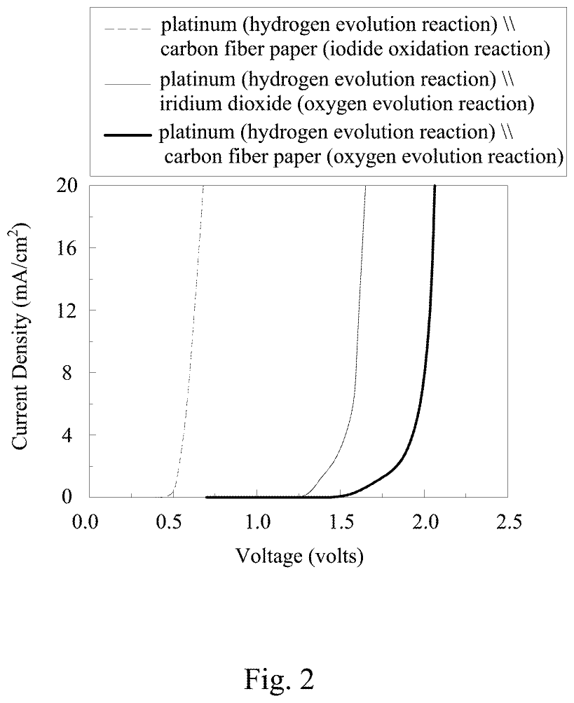

Next, linear sweep voltammetry (LSV) was used to compare required voltage of each electrolysis system at each current density, thereby evaluating energy consumption of each system. Please refer to FIG. 2 for the results (the cathode was made of platinum, and the cathode reaction solution was 0.5 M sulfuric acid).

FIG. 2 presents that at the same current density, the voltages at which the anodes performed oxygen evolution reaction (corresponding to “platinum (hydrogen evolution reaction)\\iridium dioxide (oxygen evolution reaction)” and “platinum (hydrogen evolution reaction)\\carbon fiber paper (oxygen evolution reaction)” of FIG. 2, the anode used iridium dioxide or carbon fiber paper) were higher than the required voltage at which the anode performed iodide oxidation reaction (corresponding to “platinum (hydrogen evolution reaction) \\carbon fiber paper (iodide oxidation reaction)” of FIG. 2), in which at the same current density, the order of the voltages from high to low was “platinum (hydrogen evolution reaction) \\carbon fiber paper (oxygen evolution reaction)”, “platinum (hydrogen evolution reaction) \\iridium dioxide (oxygen evolution reaction)” and “platinum (hydrogen evolution reaction) \\carbon fiber paper (iodide oxidation reaction).” For example, when the current density was 10 mA/cm², the voltages were respectively about 2.0V, about 1.6V, and about 0.59V in sequence. That is, compared with performing oxygen evolution reaction, the anode performing iodide oxidation reaction required the lower voltage.

In addition, because the products in iodide oxidation reaction (e.g., I₃⁻ or I₂) were unable to pass through the spacer to the cathode, the applied potential for electrolysis across the anode reaction chamber and the cathode reaction chamber 120 is low enough to avoid O₂ evolution, but high enough to have I⁻ oxidation (I₂ generation), while H₂ gas is still produced in the anode reaction chamber. Thus, it will not happen that oxygen passed through the spacer when the hydrogen evolution was performed at the cathode, causing impurity in hydrogen gas at the cathode.

It should be added that, in other embodiments (not shown here), the anode of the electrolysis system made of the carbon material requires a lower voltage compared with the anode made of a non-carbon material (e.g., titanium material).

### Example 2, Comparison of Anode Material

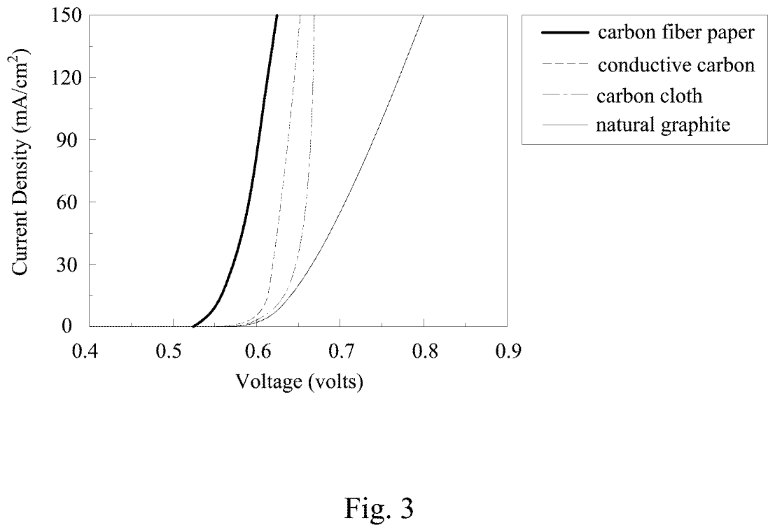

Example 2 continued to use the electrolysis system of “platinum (hydrogen evolution reaction) \\carbon fiber paper (iodide oxidation reaction)” in Example 1, and the anode reaction solution was 1M sodium iodide and 0.1M perchloric acid. Linear sweep voltammetry was also used to compare required voltage of each electrolysis system at the same current density when the anodes were made of carbon fiber paper, conductive carbon, carbon cloth, and natural graphite, respectively. Please refer to FIG. 3 for the results.

FIG. 3 presents that at the same current density (e.g., current density of 30 mA/cm²), the voltages obtained when the anodes were made of the different carbon materials. The order of the voltages from low to high was carbon fiber paper, conductive carbon, carbon cloth, natural graphite. That is, carbon fiber paper requires the lowest voltage.

### Example 3, Comparison of Anode Reaction Solution Condition

### Example 3-1, Comparison of 0.1M Perchloric Acid, 0.25M Lithium Perchlorate and 1 M Potassium Hydroxide

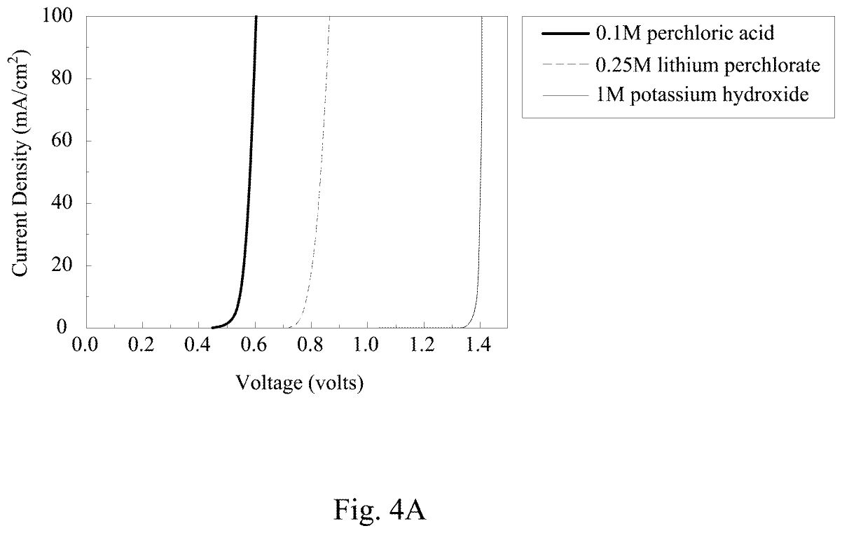

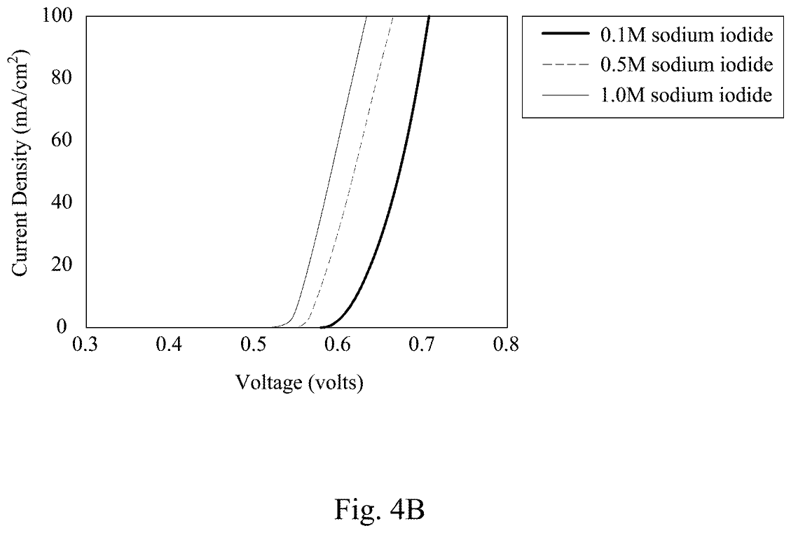

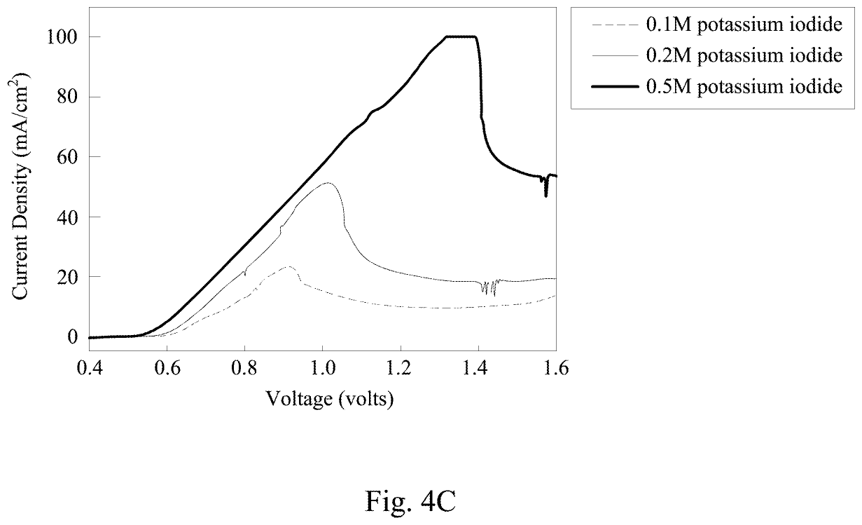

Example 3-1 continued to use the electrolysis system of “platinum (hydrogen evolution reaction) \\carbon fiber paper (iodide oxidation reaction)” in Example 1, and linear sweep voltammetry was also used to compare the difference in voltage caused by conditions of three different anode reaction solutions. Please refer to FIG. 4A for the results. Specifically, the three anode reaction solutions all included 0.1 M sodium iodide, and the difference was that the three anode reaction solutions further included 0.1 M perchloric acid, 0.25 M lithium perchlorate, and 1 M potassium hydroxide, respectively.

FIG. 4A presents that at the same current density, the voltages obtained when the different anode reaction solutions were used, and the order of the voltages from low to high was 0.1 M perchloric acid, 0.25 M lithium perchlorate, 1 M potassium hydroxide (all the three included 0.1 M sodium iodide). That is, among the three conditions, the anode reaction solution including 0.1 M perchloric acid (including 0.1 M sodium iodide) requires the lowest voltage.

### Example 3-2, Comparison of Different Sodium Iodide Concentrations

Example 3-2 continued to use the electrolysis system of “platinum (hydrogen evolution reaction) \\carbon fiber paper (iodide oxidation reaction)” in Example 1, and linear sweep voltammetry was also used to compare the difference in voltage caused by conditions of three anode reaction solutions with different concentrations of sodium iodide. Please refer to FIG. 4B for the results. The three anode reaction solutions all included 0.1 M perchloric acid, and the difference was that the three further included different concentrations of sodium iodide, which were 0.1 M sodium iodide, 0.5 M sodium iodide, and 1.0 M sodium iodide, respectively.

FIG. 4B presents that at the same current density, the voltages obtained when the different anode reaction solutions were used, and the order of the voltages from low to high was 1.0 M sodium iodide, 0.5 M sodium iodide, 0.1 M sodium iodide (all the three included 0.1 M perchloric acid). That is, the required voltage decreases when the concentration of sodium iodide increases.

### Example 3-3, Comparison of Different Potassium Iodide Concentrations

Example 3-3 adopted a electrolysis system with a concept similar to that of “platinum (hydrogen evolution reaction) \\carbon fiber paper (iodide oxidation reaction)” in Example 1. The difference was that the anode was changed to carbon cloth, and sodium iodide in the anode reaction solution was changed to potassium iodide, and the gas condition was set to a saturated argon state, and the cathode was changed to graphite, and the reference electrode was changed to a reversible hydrogen electrode. Next, linear sweep voltammetry was used to compare the difference in voltage caused by conditions of the three anode reaction solutions with different concentrations of potassium iodide. Please refer to FIG. 4C for the results. The three anode reaction solutions all included 0.1 M perchloric acid, and the difference was that the three further included different concentrations of potassium iodide, which were 0.1 M potassium iodide, 0.2 M potassium iodide, and 0.5 M potassium iodide, respectively.

FIG. 4C presents that at the same current density, the voltage obtained when the different anode reaction solutions were used, and the order of the voltages from low to high was 0.5 M potassium iodide, 0.2 M potassium iodide, 0.1 M potassium iodide (all the three included 0.1 M perchloric acid). That is, the required voltage decreases when the concentration of potassium iodide increases.

According to the results of Examples 3-2 and 3-3, it could be observed that the electrolysis system had a tendency for the required voltage to decrease as the solute concentration of the anode reaction solution increased.

### Example 4, Comparison of Different Spacer Materials

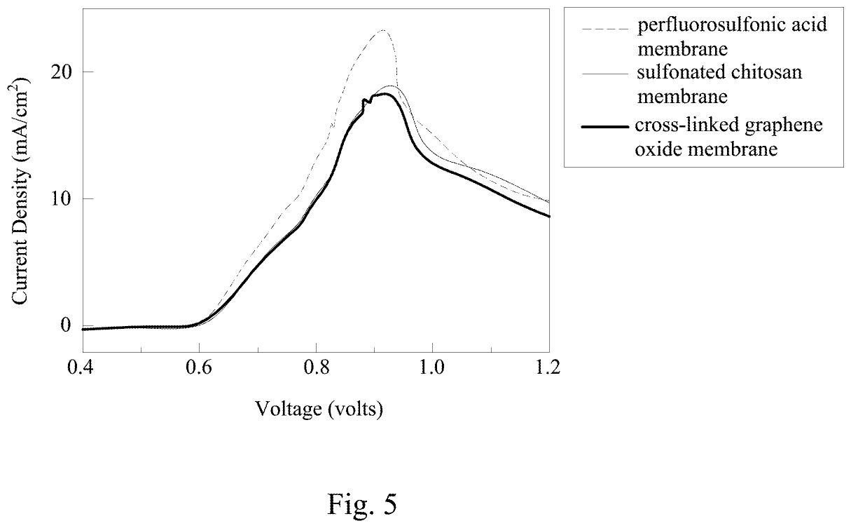

Example 4 adopted a electrolysis system with a concept similar to that of Example 3-3, and the difference was that the anode reaction solution was 0.1 M potassium iodide and 0.1 M perchloric acid. Next, linear sweep voltammetry was used to compare the difference in voltage caused by three electrolysis systems using different spacers (the perfluorosulfonic acid membrane, sulfonated chitosan membrane, and cross-linked graphene oxide membrane), respectively. Please refer to FIG. 5 for the results, in which the cross-linked graphene oxide membrane was obtained by cross-linking between glutaraldehyde and graphene oxide (e.g., cross-linking at 60° C.), so that graphene oxide with a two-dimensional structure was cross-linked with glutaraldehyde to form the cross-linked graphene oxide membrane with a three-dimensional structure.

FIG. 5 shows that the perfluorosulfonic acid membrane had the highest current density and lower initial voltage, and at the same current density (e.g., 10 mA/cm²), the required voltage was lower than that of the sulfonated chitosan membrane or the cross-linked graphene oxide membrane. In addition, it was also observed that compared with the perfluorosulfonic acid membrane and the cross-linked graphene oxide membrane, the sulfonated chitosan membrane had more serious iodine deposition issues, which was unable to be removed even after shaking cleaning.

Based on the above, the hydrogen-generating electrolysis system of the present application allows the anode to perform iodine oxidation reaction by adjusting the composition of the anode reaction solution. Compared with oxygen evolution reaction performed by the anode in the conventional water electrolysis system, it can reduce the energy required for electrolysis reaction and reduce electricity cost of the hydrogen production process, thereby increasing the value or profit of the unit electricity output of the overall production, and obtains solid iodine with high commercial value at the same time.

The features of several embodiments of the present application have been briefly described above, so that those skilled in the art can understand the present application more easily. Any of those skilled in the art should understand that this description can be easily used as the basis for other structural or process changes or designs, so as to achieve the same purpose and/or obtain the same advantages as the embodiments of the present application. Any of those skilled in the art can also understand that the structures equivalent to the above do not depart from the spirit and protection scope of the present application, and can be changed, replaced and modified without departing from the spirit and scope of the present application.

What is claimed is:

1. An electrolysis system, comprising:
an anode reaction chamber, comprising an anode reaction solution and an anode immersed in the anode reaction solution, wherein the anode reaction solution includes an iodide ion, and a material of the anode includes a carbon material, and the anode reaction chamber performs an iodide oxidation reaction;
a cathode reaction chamber, comprising a cathode reaction solution and a cathode immersed in the cathode reaction solution, wherein the cathode reaction solution includes a hydrogen ion; and
a spacer, separating the anode reaction chamber and the cathode reaction chamber, wherein the spacer allows a cation or an anion to pass through;
the anode reaction chamber and the cathode reaction chamber are electrically connected to each other.

2. The electrolysis system of claim 1, wherein the material of the anode is made of the carbon material.

3. The electrolysis system of claim 1, wherein the anode comprises an anode body and an anode catalyst layer disposed on the anode body, wherein a material of the anode body or the anode catalyst layer includes the carbon material.

4. The electrolysis system of claim 1, wherein the carbon material comprises a carbon fiber paper, a conductive carbon, a carbon cloth, a graphite, a carbon sphere or a combination thereof.

5. The electrolysis system of claim 1, wherein the carbon material is not subjected to surface modification treatment or is subjected to surface modification treatment.

6. The electrolysis system of claim 1, wherein the anode reaction solution comprises a first solute and a second solute.

7. The electrolysis system of claim 6, wherein the first solute comprises metal iodide, and the second solute comprises perchloric acid, perchlorate, metal hydroxide, or a combination thereof.

8. The electrolysis system of claim 6, wherein a concentration of the first solute in the anode reaction solution is in a range of from 5×104 M to 2 M, and a concentration of the second solute in the anode reaction solution is in a range of from 0.05 M to 2 M.

9. The electrolysis system of claim 1, wherein comparing with oxygen, the iodide ion, an iodine molecule, a triiodide ion or a combination thereof is less available to pass through the spacer.

10. The electrolysis system of claim 1, wherein the spacer comprises a perfluorosulfonic acid membrane, a sulfonated chitosan membrane, a cross-linked graphene oxide membrane, or a combination thereof.

11. An electrolysis system, comprising:
an anode reaction chamber, comprising an anode reaction solution and an anode immersed in the anode reaction solution, wherein the anode reaction solution includes an iodide ion, and a material of the anode is made of a carbon material, and the anode reaction chamber performs an iodide oxidation reaction; and
a cathode reaction chamber, comprising a cathode reaction solution and a cathode immersed in the cathode reaction solution, wherein the cathode reaction solution includes a hydrogen ion.

12. The electrolysis system of claim 11, further comprising:
a spacer, separating the anode reaction chamber and the cathode reaction chamber, wherein the spacer allows a cation or an anion to pass through, so that the anode reaction chamber and the cathode reaction chamber are electrically connected to each other.

13. The electrolysis system of claim 11, wherein the carbon material comprises a carbon fiber paper, a conductive carbon, a carbon cloth, a graphite, a carbon sphere or a combination thereof.

14. The electrolysis system of claim 11, wherein a material of the cathode comprises platinum.

15. The electrolysis system of claim 11, wherein the anode reaction chamber further comprises a reference electrode immersed in the anode reaction solution.
